(19) United States
(12) Patent Application Publication
(10) Pub. No.: US 2011/0265595 A1
(43) Pub. Date: Nov. 3, 2011

(54) SHIFT LEVER APPARATUS

(75) Inventors: Norihito SHIOJI, Kosai-shi (JP); Taizo YASUDA, Hamamatsu-shi (JP)

(73) Assignee: FUJI KIKO CO., LTD., Kosai-shi (JP)

(21) Appl. No.: 13/093,893

(22) Filed: Apr. 26, 2011

(30) Foreign Application Priority Data
Apr. 28, 2010 (JP) P2010-103900

(51) Int. Cl. F16H 59/04

(52) U.S. Cl. 74/473.3

(57) ABSTRACT

A pair of wiring structures 9 and 9 configured to transmit a control signal from an operating switch on an upper portion of a shift lever 3 to a vehicle body side respectively include connection terminals 91 to be attached to a framework portion of a knob 4. Each connection terminal 91 includes: a connecting portion 93 on an end of the connection terminal 91, the connecting portion 93 being connectable to an opponent terminal; a hook portion 95 to which an end portion 90a of a lead wire 90 is to be fixed, the hook portion 95 located on another end of the connection terminal 91; and an insertion portion 92 and a position regulating portion 94 between the connecting portion 93 and the hook portion 95, the insertion portion 92 being inserted into an insertion hole in a bracket 50, the position regulating portion 94 being configured to regulate a position of the insertion portion 92 in the inserting direction.

### TECHNICAL FIELD

The present invention relates to a shift lever apparatus including a shift lever provided with a knob on an upper portion thereof and configured to change a shift position by a turning operation.

### RELATED ART

Conventional shift lever apparatuses of this type include one in which a knob on an upper portion of a shift lever is provided with an operating switch for outputting a control signal for switching to an overdrive mode and the like to a vehicle body side. Conventional examples of this apparatus are disclosed in Patent Literature 1 and Patent Literature 2.

As shown in FIG. 1, a shift lever apparatus 100 disclosed in Patent Literature 1 includes a shift lever 102 provided in a housing (not shown) fixed to a vehicle body and configured to turn around a rotating shaft 101. A knob button 104 and an overdrive operating switch 105 are attached to a knob 103 on an upper portion of this shift lever 102 and this operating switch 105 is connected to harnesses 109 on the shift lever 102 side via a pair of lead wires 106. The lead wires 106 are disposed respectively in guide grooves 112 on a framework 111 of the knob 103 and protrude from terminal insertion holes 108 located on a lower end of the framework 111. The pair of harnesses 109 locked with a locking member 113 are routed on the shift lever 102 side and cylindrical female terminals 110 are provided on these harnesses 109.

In this conventional example, when the shift lever 102 and the knob 103 are assembled together, the lead wires 106 on the knob 103 side are fitted into the female terminals 110 on the shift lever 102 side, so that electric connection is established between the lead wires 106 and the harnesses 109. When a driver grips the knob 103 and presses the operating switch 105 in this condition, a control signal is sent to the vehicle body side via the lead wires 106 and the harnesses 109. Hence, overdrive switching control is performed by a transmission.

As shown in FIGS. 2 and 3, a shift lever apparatus 120 disclosed in Patent Literature 2 includes a shift lever 121, which is provided in a housing (not shown) fixed to a vehicle body and configured to turn around a rotating shaft (not shown). A knob 122 capable of being gripped by a driver is attached to an upper portion of this shift lever 121 and a lower portion of the shift lever 121 is covered with a cover 123. A knob button 124 and an overdrive operating switch 125 are attached to the knob 122 and the operating switch 125 is electrically connected to a transmission (not shown) on the vehicle body side via a wiring structure 126 provided along the shift lever 121. The wiring structure 126 is disposed inside the knob 122 and the cover 123 and is formed of an unillustrated harness member obtained by insert-molding a conductive plate with resin, the conductive plate being made by punching a conductive metal plate into an elongated shape. An upper end of the conductive plate is formed into a pin shape and thus is connectable to the operating switch 125 via a connector (not shown). Similarly, a lower end of the conductive plate is formed into a pin shape and thus is connectable to a connector (not shown) of wiring that extends to the transmission on the vehicle body side.

In this conventional example, when the shift lever 121 and the knob 122 are assembled together, the wiring structure 126 is provided inside the knob 122 and the cover 123 along the shift lever 121. Moreover, the upper end of the wiring structure 126 is connected to the operating switch 125 via the connector while the lower end of the wiring structure 126 is connected to the wiring, which extends to the transmission on the vehicle body side, via the connector. When a driver grips the knob 122 and presses the operating switch 125 in this condition, a control signal is sent to the vehicle body side via the wiring structure 126. Hence, overdrive switching control is performed by the transmission.

### [Citation List]

### [Patent Literatures]

[Patent Literature 1] Japanese Patent Application Laid-Open No. Hei 8-303561

### [Patent Literature 2] Japanese Patent Application Laid-Open No. 2009-12624

### SUMMARY OF INVENTION

### Technical Problems

The apparatus described in Patent Literature 1, however, requires that the terminal insertion holes 108 from which the lead wires 106 protrude and the guide grooves 112 be provided at the lower end of the framework 111. Since each lead wire 106 has a columnar shape with a small diameter, a die (not shown) for forming the terminal insertion holes 108 has a very small diameter and a poor durability, leading to a problem of a short life and cost increase.

Meanwhile, in the apparatus disclosed in Patent Literature 2, the wiring structure 126 is formed of the harness member obtained by insert-molding the conductive plate with resin. Therefore, this apparatus also has a problem of a cost increase.

The present invention has been made to solve the foregoing problems and an object thereof is to provide a shift lever apparatus which is capable of electrically connecting an operating switch provided to a knob at an upper portion of a shift lever reliably to a vehicle body side at a relatively low cost.

### Solution to Problems

A first aspect of the present invention is a shift lever apparatus to be provided on a housing fixed to a vehicle body. The shift lever apparatus includes: a shift lever configured to turn around a rotating shaft; a knob including a framework portion fixed to an upper portion of the shift lever; an operating switch provided on the knob and being capable of outputting a control signal; and a wiring structure configured to transmit the control signal, outputted from the operating switch, to a vehicle body side. In the above-described configuration, the wiring structure includes: a connection terminal attached to the framework portion; a connecting portion on one end of the connection terminal and rendered connectable to an opponent terminal; a hook portion to which an end portion of a lead wire extending along the framework portion from the operating switch is fixed, the hook portion located on another end of the connection terminal; and an insertion portion and a position regulating portion comprised between the connecting portion and the hook portion, the insertion portion being configured to be inserted into an insertion hole formed in the framework portion, the position regulating portion being configured to regulate a position of the insertion portion.

A second aspect of the present invention is the shift lever apparatus according to the first aspect, in which the end portion of the lead wire is bent perpendicularly to an extending direction of the lead wire, and the hook portion is curved in such a manner as to wrap around the end portion of the lead wire and the end portion of the lead wire is fixed to the hook portion by welding.

A third aspect of the present invention is the shift lever apparatus according to the first aspect, in which the insertion portion is formed to have a substantially U-shaped cross section.

A fourth aspect of the present invention is the shift lever apparatus according to the first aspect, in which the position regulating portion includes: an insertion regulating surface abutting on an end surface of the insertion hole formed in the framework portion; and a retaining surface abutting on an end portion of a retaining protrusion provided on the framework portion.

A fifth aspect of the present invention is the shift lever apparatus according to the fourth aspect, in which the retaining protrusion includes a flexible tapered surface which gradually slopes upward in an inserting direction of the insertion portion, and the position regulating portion slides on the tapered surface when the insertion portion is inserted into the insertion hole in the framework portion.

### ADVANTAGEOUS EFFECTS OF INVENTION

According to the first aspect of the present invention, the wiring structure including the connection terminal and the lead wire is integrated by fixing the end portion of the lead wire to the hook portion of the connection terminal, and then the connection terminal is attached to the predetermined position of the framework portion of the knob by inserting the insertion portion of the connection terminal to the insertion hole formed in the framework portion of the knob and regulating the position in the inserting direction of the insertion portion by using the position regulating portion. Subsequently, when the knob is attached to the upper portion of the shift lever, the connecting portion of the connection terminal is connected to the opponent terminal. Accordingly, the use of the lead wire and the connection terminal as the wiring structure has an effect of cost reduction as compared to the conventional case of using the harness member obtained by insert-molding the conductive plate. Moreover, it is possible to establish electrical connection to the vehicle body side reliably by connecting the connecting portion of the connection terminal to the opponent terminal. Furthermore, since the lead wire and the connection terminal are separately provided, the wiring structure is capable of being adapted to various specifications by changing dimensions of the connection terminal.

According to the second aspect of the present invention, the end portion of the lead wire can be kept away from the position regulating portion and the connecting portion by being bent perpendicularly to the extending direction of the lead wire. Hence, the position regulating portion and the connecting portion are prevented from deforming attributable to a thermal effect at the time of welding. Furthermore, since the hook portion is curved in such a manner as to wrap around the end portion of the lead wire, the end portion of the lead wire can be fixed to the hook portion reliably by welding.

According to the third aspect of the present invention, the insertion portion to be inserted into the insertion hole in the framework portion is formed to have a substantially U-shaped cross section. Therefore, it is possible to increase the cross-sectional area of the insertion hole in the framework portion as compared to the conventional case of providing the insertion holes into which the columnar female terminals are inserted. The increase in cross-sectional area of a die for forming the insertion hole can improve durability and life of the die and thus achieve cost reduction in this regard as well.

According to the fourth aspect of the present invention, when the insertion portion of the connection terminal is inserted into the insertion hole formed in the framework portion of the knob, the position of the insertion portion is regulated in the inserting direction by bringing the insertion regulating surface of the position regulating portion into contact with the end surface of the insertion hole formed in the framework portion. Hence, it is possible to attach the connection terminal while the connection terminal is positioned to a predetermined position on the framework portion of the knob. Moreover, it is possible to retain the connection terminal reliably by bringing the retaining surface of the position regulating portion into contact with the end portion of the retaining protrusion provided on the framework portion with the connection terminal attached to the predetermined position of the framework portion of the knob.

According to the fifth aspect of the present invention, when the insertion portion of the connection terminal is inserted into the insertion hole formed in the framework portion of the knob, the position regulating portion slides on the tapered surface gradually sloping upward in the inserting direction of the insertion portion and gradually rises,. Meanwhile, the retaining protrusion is bent toward the framework portion. Subsequently, as the position regulating portion passes over the retaining protrusion, flexure deformation of the retaining protrusion is released back to the original state and the retaining surface of the position regulating portion abuts on the end portion of the retaining protrusion. Thus, the connection terminal is retained. In this way, it is possible to attach the connection terminal easily to the framework portion of the knob.

### BRIEF DESCRIPTION OF DRAWINGS

FIG. 1 is a side view showing a conventional shift lever apparatus.

FIG. 2 is a side view showing a different conventional shift lever apparatus.

FIG. 3 is a cross-sectional view showing the different conventional shift lever apparatus.

FIG. 4 is a side view of a shift lever apparatus according to an embodiment of the present invention.

FIG. 5 is an exploded perspective view of the shift lever apparatus according to the embodiment of the present invention.

FIG. 6 is an enlarged front elevation view showing a state where a cover is detached from a framework portion of a knob according to the embodiment of the present invention.

FIG. 7 is a side view of the apparatus according to the embodiment of the present invention viewed in a direction indicated by an arrow VII in FIG. 6.

FIG. 8 is a cross-sectional view of the apparatus according to the embodiment of the present invention taken along a VIII-VIII line and viewed in a direction indicated by arrows VIII in FIG. 6.

FIG. 9 is a perspective view of one of connection terminals according to the embodiment of the present invention.

FIG. 10 is a perspective view of the knob according to the embodiment of the present invention, when seen from another direction with the cover detached therefrom.

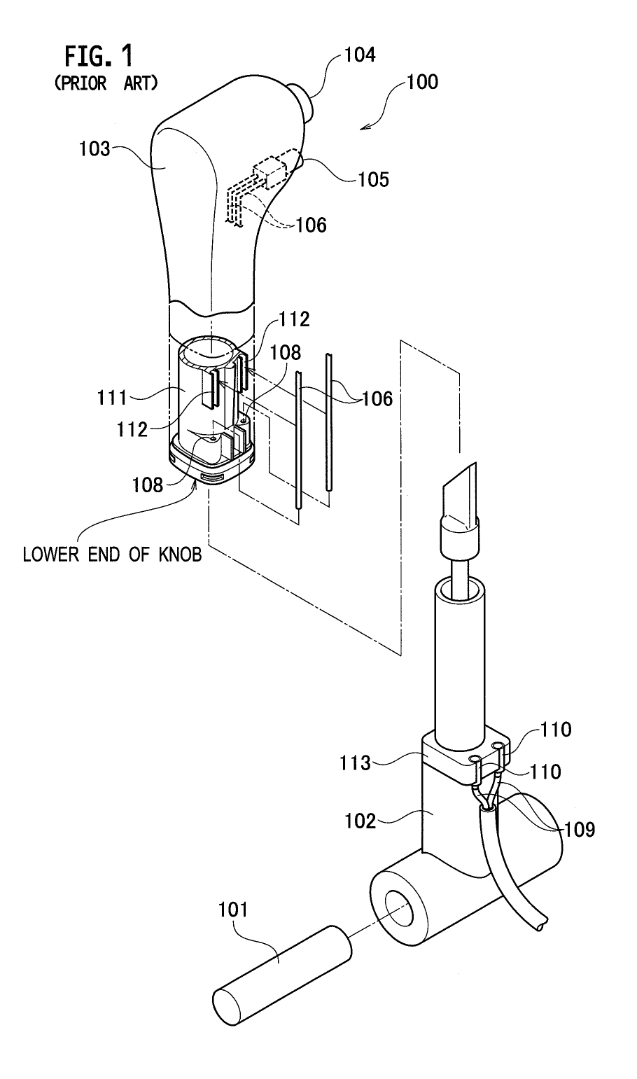

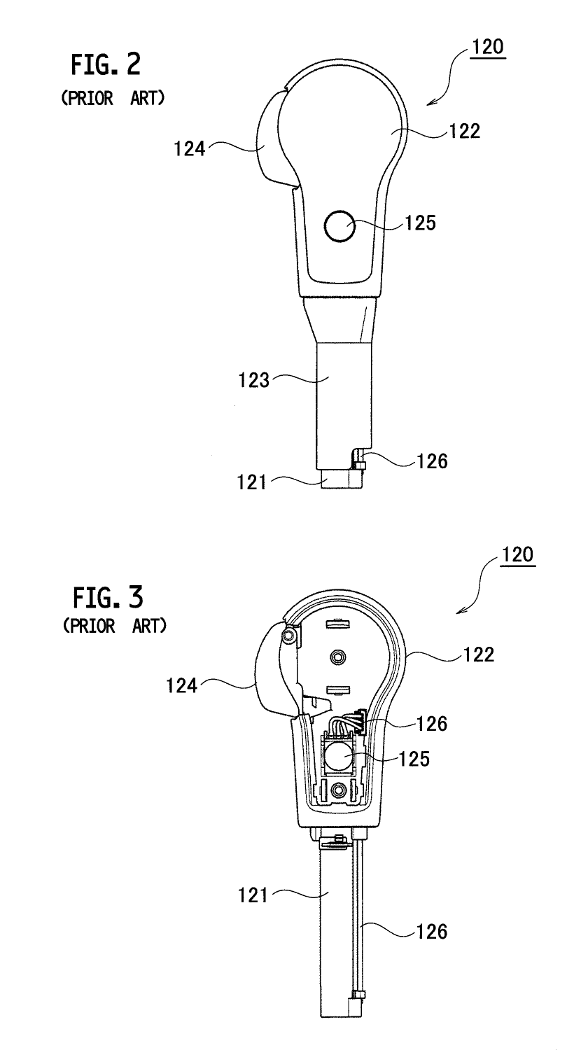

### DESCRIPTION OF EMBODIMENTS

Now, an embodiment of the present invention will be described below with reference to the accompanying drawings.

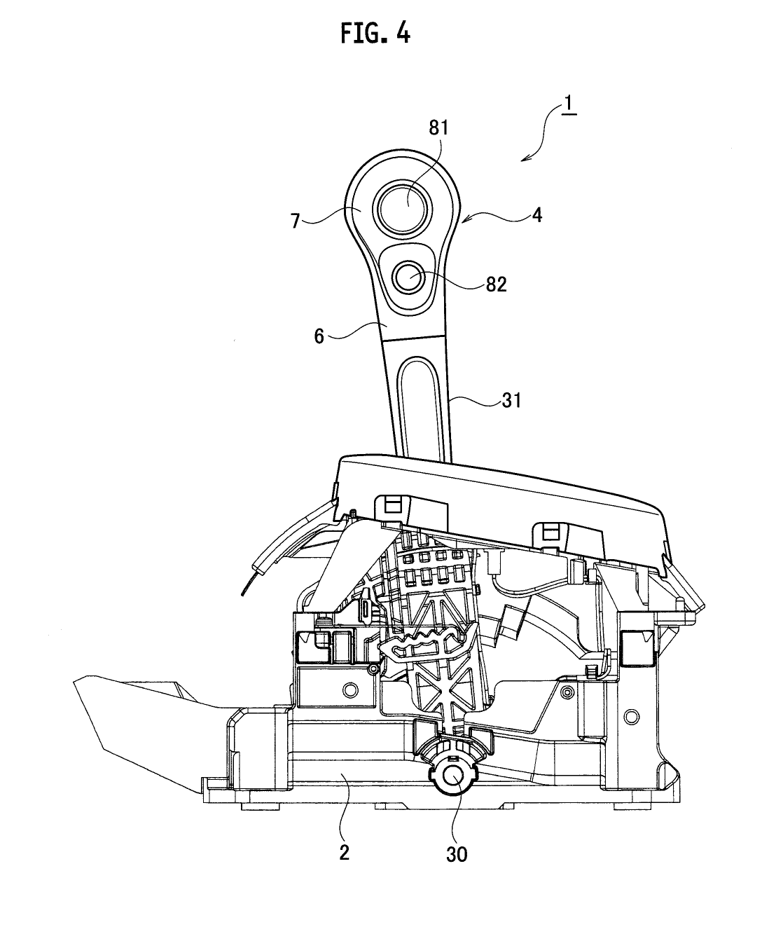

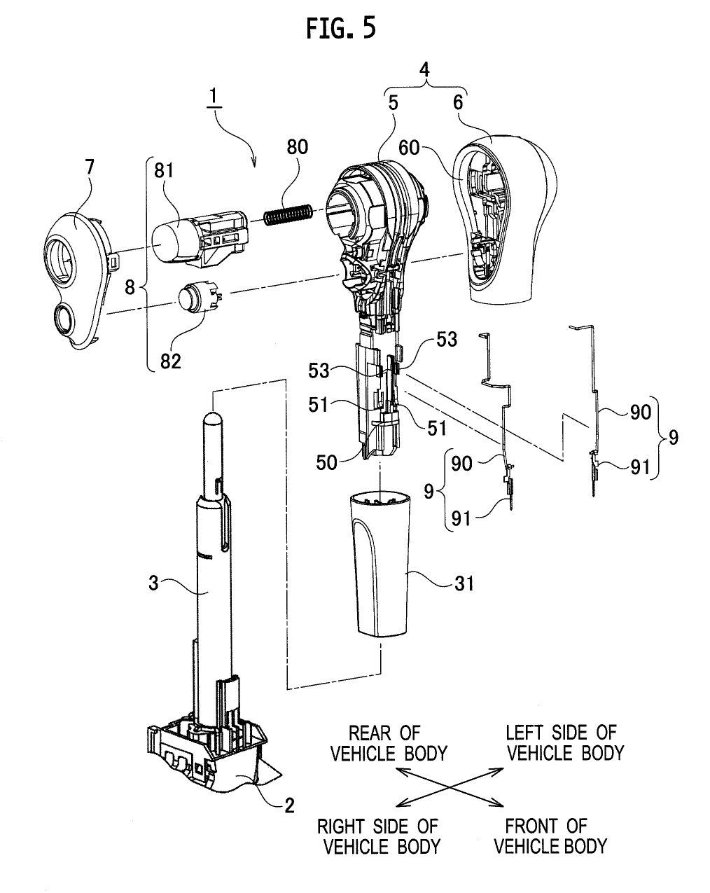

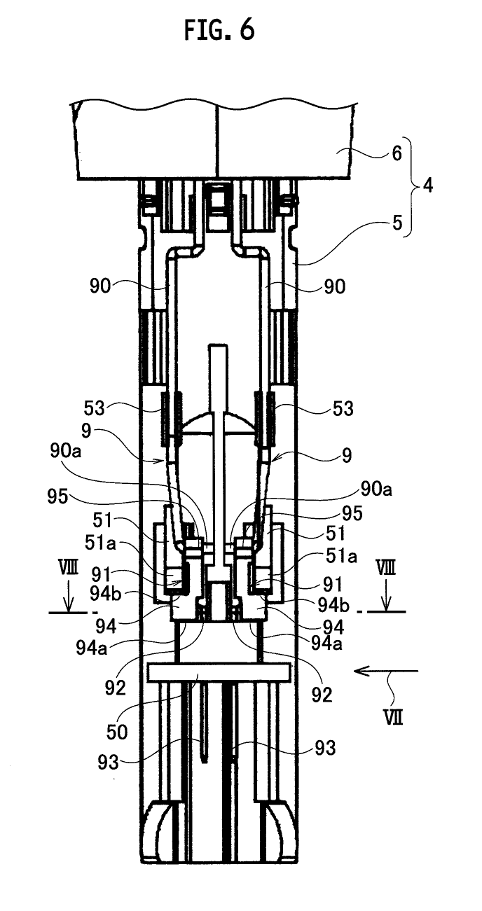

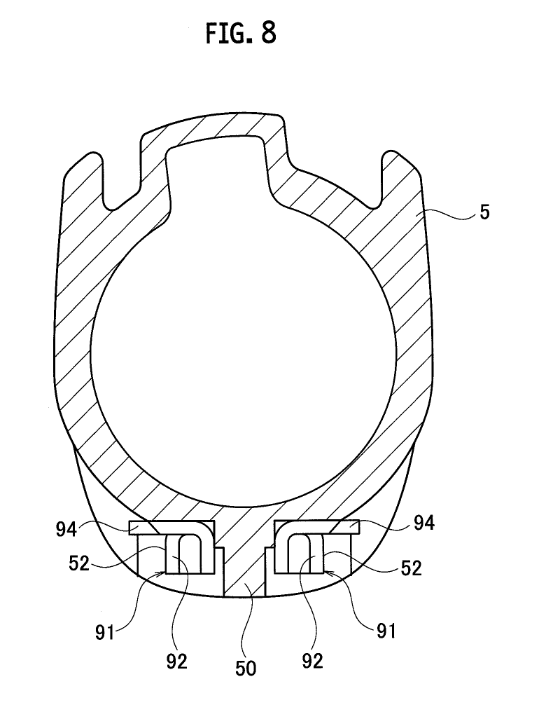

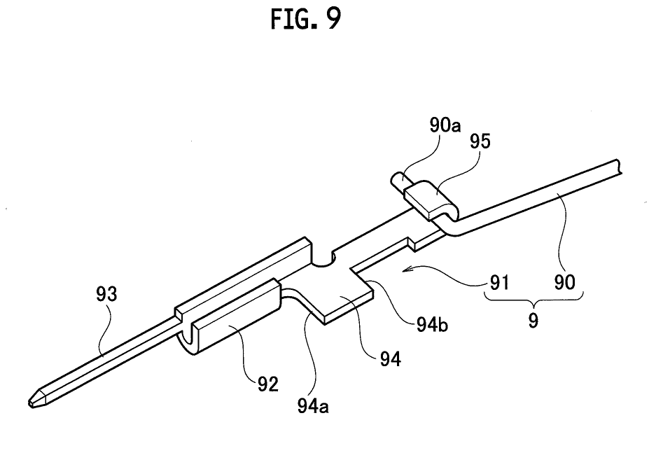

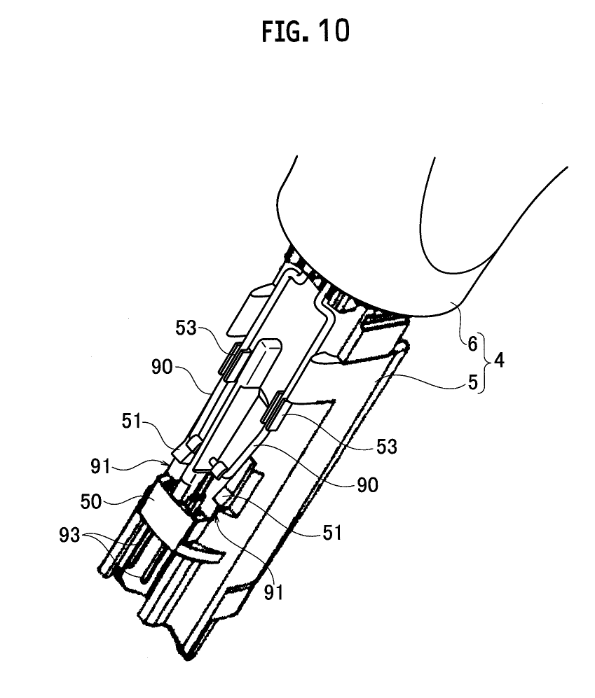

As shown in FIGS. 4 to 10, a shift lever apparatus 1 of this embodiment includes a shift lever 3 provided on a housing 2 fixed to a vehicle body (not shown) and configured to turn around a rotating shaft 30. A knob 4 capable of being gripped by a driver is fixed to an upper portion of the shift lever 3 and a lower portion of a framework portion 5, which will be described later, of the knob 4 is covered with a cover 31.

The knob 4 includes the framework portion 5 which is attached to the upper portion of the shift lever 3 and constitutes a framework of the knob 4, an envelope portion 6 molded on the framework portion 5, a cover portion 7 attached in such a manner as to cover an opening 60 of this envelope portion 6, and an operating unit 8 housed in the framework portion 5.

The operating unit 8 includes a knob button 81 biased by a coil spring 80, and an operating switch 82. Upper ends of the knob button 81 and the operating switch 82 for overdrive and the like are exposed out of the cover portion 7.

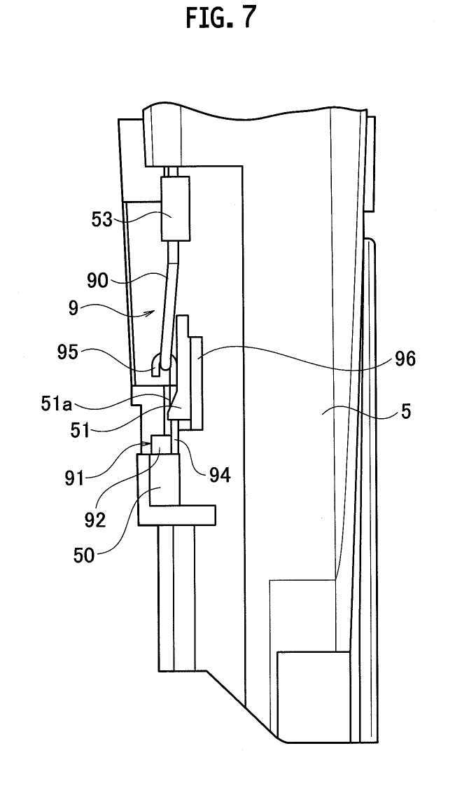

A pair of left and right wiring structures 9 and 9 for electrically connecting the operating switch 82 to a transmission (not shown) on the vehicle body side are attached to the framework portion 5. Moreover, the framework portion 5 includes a bracket 50 and a pair of left and right retaining protrusions 51 and 51 integrally formed therein. Connection terminals 91 and 91 to be described later are attached to the bracket 50, and the pair of left and right retaining protrusions 51 and 51 is configured to retain the connection terminals 91 and 91. The bracket 50 is provided with a pair of left and right insertion holes 52 and 52 which are each formed to have a rectangular cross section and extend in an axial direction of the framework portion 5 (i.e., an axial direction of the shift lever 3). Each retaining protrusion 51 is provided with a tapered surface 51 a which gradually slopes upward from an upper end side (an upper side in FIG. 7) to a lower end side (a lower side in FIG. 7), and protrudes from the framework portion 5 in a cantilever fashion in such a manner as to be bendable. A position regulating portion 94 to be described later slides on the tapered surface 51 a when the connection terminal 91 is attached to the bracket 50. For this reason, a cutout portion 96 is formed on the sole (a right side in FIG. 7) of each retaining protrusion 51.

The pair of left and right wiring structures 9 are formed to be bilaterally symmetric. Each wiring structure 9 includes a lead wire 90 and the connection terminal 91. The lead wire 90 has one end connected to the operating switch 82, and extends along the framework portion 5. The connection terminal 91 is formed by bending a conductive metal plate and connected to the other end of the lead wire 90.

The lead wire 90 is bent in the middle into a predetermined shape and an end portion 90a is formed into an L shape by being bent perpendicularly to an extending direction of the lead wire 90. Meanwhile, an intermediate part of the lead wire 90 is held by a holding portion 53 formed on the framework portion 5.

Each of the connection terminals 91 is integrally formed with an insertion portion 92, a connecting portion 93, the position regulating portion 94, and a hook portion 95. The insertion portion 92 is formed to have a substantially U-shaped cross section and is to be inserted into the insertion hole 52 of the bracket 50. The connecting portion 93 protrudes from a lower end of this insertion portion 92 in an axial direction of the connection terminal 91 and is to be fitted into a female terminal (not shown) on an opponent side. The position regulating portion 94 is located closer to the lead wire 90 than the insertion portion 92 is and protrudes in an orthogonal direction to a longitudinal direction of the connection terminal 91. The hook portion 95 is disposed closer to the lead wire 90 than this position regulating portion 94 is and is configured to fix a lower end of the lead wire 90. The hook portion 95 is formed into a curved shape in such a manner as to wrap around the end portion 90a of the lead wire 90 so that the hook portion 95 is fixed to the end portion 90a of the lead wire 90 reliably by welding.

The connecting portion 93 is formed into a quadrangular cylindrical shape and a tip end thereof is formed into a quadrangular pyramid shape. The position regulating portion 94 includes an insertion regulating surface 94a and a retaining surface 94b each extending in a direction orthogonal to the longitudinal direction of the connection terminal 91. When the connection terminal 91 is mounted on the bracket 50, the position regulating portion 94 slides on the tapered surface 51a of the retaining protrusion 51 and rises gradually and the retaining protrusion 51 is bent toward the framework portion 5. Subsequently, as the position regulating portion 94 passes over the retaining protrusion 51, flexure deformation of the retaining protrusion 51 is released back to the original state. Hence, the retaining surface 94b of the position regulating portion 94 abuts on the lower end portion of the retaining protrusion 51, thereby retaining the connection terminal 91. Meanwhile, the insertion regulating surface 94a of the position regulating portion 94 abuts on an upper end of the bracket 50, whereby the mounting positions of the insertion portion 92 and the connecting portion 93 relative to the insertion hole 52 are regulated.

In the above-described configuration, when the wiring structure 9 is assembled, the end portion 90a of the lead wire 90 is inserted into the hook portion 95 of the connection terminal 91 and is fixed to the hook portion 95 by arc welding or the like. Subsequently, the insertion portion 92 of the connection terminal 91 is inserted into the insertion hole 52 of the bracket 50 and the connecting portion 93 is caused to protrude from the insertion hole 52. At the same time, the retaining surface 94b of the position regulating portion 94 is brought into contact with the lower end portion of the retaining protrusion 51, so that the connection terminal 91 is retained. Then, the lead wire 90 is routed. The intermediate part of the lead wire 90 is held by the holding portion 53 of the framework portion 5 and then, the envelope portion 6 is molded on the framework portion 5.

As described above, according to the present invention, the wiring structure 9 includes the lead wire 90 and the connection terminal 91. Therefore, it is possible to reduce costs as compared to the conventional case of using the harness member obtained by insert-molding the conductive plate. Moreover, it is possible to establish electrical connection to the vehicle body side reliably by connecting the connecting portion 93 of the connection terminal 91 to the opponent terminal. Furthermore, since the lead wire 90 and the connection terminal 91 are separately provided, the wiring structure 9 is capable of being adapted to various specifications by changing dimensions of the connection terminal 91.

In addition, according to the present invention, the end portion 90a of the lead wire 90 can be kept away from the position regulating portion 94 and the connecting portion 93 by being bent perpendicularly to the extending direction of the lead wire 90. Hence, it is possible to prevent deformation of the position regulating portion 94 and the connecting portion 93 attributable to a thermal effect at the time of welding. Furthermore, since the hook portion 95 is curved in such a manner as to wrap around the end portion 90a of the lead wire 90, the end portion 90a of the lead wire 90 can be fixed to the hook portion 95 reliably by welding.

Meanwhile, according to the present invention, the insertion portion 92 to be inserted into the insertion hole 52 in the bracket 50 of the framework portion 5 has the cross section formed substantially into the U-shape. Therefore, it is possible to increase the cross-sectional area of the insertion hole 52 in the bracket 50 as compared to the conventional case of providing the insertion holes into which the columnar female terminals are inserted. The increase in cross-sectional area of a die for forming the insertion hole 52 can improve durability and life of the die and thus achieve cost reduction in this regard as well.

Meanwhile, according to the present invention, when the insertion portion 92 of the connection terminal 91 is inserted into the insertion hole 52 of the bracket 50, the position regulating portion 94 slides on the tapered surface 51 a gradually sloping upward in the inserting direction of the insertion portion 92 and gradually rises. Meanwhile, the retaining protrusion 51 is bent toward the framework portion 5. Subsequently, as the position regulating portion 94 passes over the retaining protrusion 51, flexure deformation of the retaining protrusion 51 is released back to the original state and the retaining surface 94b of the position regulating portion 94 abuts on the end portion of the retaining protrusion 51. Accordingly, it is possible to attach the connection terminal 91 easily to the framework portion 5 of the knob 4 and to reliably retain the connection terminal 91. Moreover, the position in the inserting direction of the insertion portion 92 is regulated by bringing the insertion regulating surface 94a of the position regulating portion 94 into contact with the end surface of the insertion hole 52 of the bracket 50. Hence, it is possible to attach the connection terminal 91 while the connection terminal 91 is positioned to a predetermined position on the framework portion 5 of the knob 4.

The entire contents of Japanese Patent Application No. 2010-103900 (filed on Apr. 28, 2010) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A shift lever apparatus to be provided on a housing fixed to a vehicle body, comprising:
a shift lever configured to turn around a rotating shaft;
a knob including a framework portion fixed to an upper portion of the shift lever;
an operating switch provided on the knob and being capable of outputting a control signal; and
a wiring structure configured to transmit the control signal, outputted from the operating switch, to a vehicle body side,
wherein the wiring structure includes:
a connection terminal attached to the framework portion;
a connecting portion on one end of the connection terminal, the connecting portion being connectable to an opponent terminal;
a hook portion to which an end portion of a lead wire extending along the framework portion from the operating switch is fixed, the hook portion located on another end of the connection terminal; and
an insertion portion and a position regulating portion comprised between the connecting portion and the hook portion, the insertion portion being configured to be inserted into an insertion hole formed in the framework portion, the position regulating portion being configured to regulate a position of the insertion portion.

2. The shift lever apparatus according to claim 1,
wherein the end portion of the lead wire is bent perpendicularly to an extending direction of the lead wire, and
the hook portion is curved in such a manner as to wrap around the end portion of the lead wire and the end portion of the lead wire is fixed to the hook portion by welding.

3. The shift lever apparatus according to claim 1,
wherein the insertion portion is formed to have a substantially U-shaped cross section.

4. The shift lever apparatus according to claim 1,
wherein the position regulating portion comprises:
an insertion regulating surface abutting on an end surface of the insertion hole formed in the framework portion; and
a retaining surface abutting on an end portion of a retaining protrusion provided on the framework portion.

5. The shift lever apparatus according to claim 4,
wherein the retaining protrusion comprises a flexible tapered surface which gradually slopes upward in an inserting direction of the insertion portion, and
the position regulating portion slides on the tapered surface when the insertion portion is inserted into the insertion hole in the framework portion.
